(19) United States
(12) Patent Application Publication
(10) Pub. No.: US 2026/0251933 A1
(43) Pub. Date: Aug. 27, 2026

(54) DISPLAY DEVICE

(71) Applicant: HANNSTAR DISPLAY CORPORATION, Taipei city (TW)

(72) Inventors: Yu-Chi Chiao, Taipei city (TW); Yu-Cheng Lin, Taipei City (TW); Chia-Feng Teng, Taipei city (TW); Ting-Wei Liu, Taipei city (TW); Chia-Yu Liu, Taipei city (TW)

(73) Assignee: HANNSTAR DISPLAY CORPORATION, Taipei city (TW)

(21) Appl. No.: 19/433,026

(22) Filed: Dec. 25, 2025

(30) Foreign Application Priority Data
Feb. 21, 2025 (TW) 114106510
Feb. 27, 2025 (TW) 114107273

(51) Int. Cl. G02F 1/1335; G02F 1/13363; G02F 1/1343

(52) U.S. Cl. CPC G02F 1/133555; G02F 1/133512; G02F 1/133519; G02F 1/133531; G02F 1/133638; G02F 1/13439

(57) ABSTRACT

The present invention provides a display device including a transflective display panel, a backlight module disposed, and a light-adjusting panel disposed between the transflective display panel and the backlight module. The transflective display panel includes a first substrate, a second substrate, a first circuit layer disposed on the first substrate, a plurality of reflective electrodes disposed on the first circuit layer, a first color filter layer including a plurality of color filters and disposed on the second substrate, and a first liquid crystal layer disposed between the color filters and the reflective electrodes. Each of the reflective electrodes includes an opening, and each of the color filters corresponds to one of the reflective electrodes. The light-adjusting panel includes a third substrate, a fourth substrate, a second circuit layer disposed on the third substrate, and a second liquid crystal layer disposed between the second circuit layer and the fourth substrate.

### BACKGROUND OF THE INVENTION

### 1. FIELD OF THE INVENTION

The present invention relates to a display device and particularly to a transflective display device.

### 2. DESCRIPTION OF THE PRIOR ART

With the progress of technology, various types of display devices have been developed. Among them, owing to the transflective display device utilizes the ambient light as part of its light source to achieve display functionality, the transflective display device has an advantage of low power consumption. Many electronic devices nowadays, such as a hand-writing panel, an electronic paper, a tablet PC, a laptop, etc., have products adopting the transflective display panels. However, in the traditional transflective display device, since only the openings of the reflective electrodes allow light emitted by the backlight module to pass through, the brightness of the image is relatively low, resulting in a low contrast ratio of the image; and although reducing the thickness of the color filter layer of the transflective display device may increase the brightness of the image, it causes reducing the color saturation of the image, which affects the user experience. In addition, in the traditional transflective display device, multiple layers of optical elements (e.g., wave plates, polarizers) are disposed, which causes reducing the transmittance of the display device. Hence, how to enhance the image quality of the transflective display device is one of the objectives of the present invention.

### SUMMARY OF THE INVENTION

The technical problem that the present invention intends to solve is how to enhance the image quality of the transflective display device.

To solve the above-mentioned technical problem, an embodiment of the present invention provides a display device including a transflective display panel, a backlight module disposed on a side of the transflective display panel, and a light-adjusting panel disposed between the transflective display panel and the backlight module. The transflective display panel has a plurality of sub-pixels and includes a first substrate, a second substrate disposed opposite to the first substrate, a first circuit layer disposed on a surface of the first substrate, a plurality of reflective electrodes disposed on the first circuit layer, a first color filter layer including a plurality of color filters and disposed on a surface of the second substrate, and a first liquid crystal layer disposed between the plurality of color filters and the plurality of reflective electrodes. Each of the plurality of reflective electrodes includes an opening, and each of the plurality of color filters corresponds to one of the plurality of reflective electrodes and is disposed in one of the plurality of sub-pixels. The light-adjusting panel includes a third substrate, a fourth substrate disposed opposite to the third substrate, a second circuit layer disposed on a surface of the third substrate, and a second liquid crystal layer disposed between the second circuit layer and the fourth substrate.

Another embodiment of the present invention provides a display device including a transflective display panel, a backlight module disposed on a side of the transflective display panel, and a light-adjusting panel disposed between the transflective display panel and the backlight module. The transflective display panel includes a first polarizer, a second polarizer disposed opposite to the first polarizer, a first liquid crystal layer disposed between the first polarizer and the second polarizer, a first quarter wave plate disposed between the first liquid crystal layer and the first polarizer, a second quarter wave plate disposed between the first liquid crystal layer and the second polarizer, a first substrate disposed between the first quarter wave plate and the first liquid crystal layer, and a second substrate disposed between the second quarter wave plate and the first liquid crystal layer. The light-adjusting panel includes a third polarizer, a second liquid crystal layer disposed between the third polarizer and the first polarizer, a third substrate disposed between the second liquid crystal layer and the third polarizer, and a fourth substrate disposed between the first polarizer and the second liquid crystal layer.

The present invention may enhance the contrast ratio of the display device by disposing the light-adjusting panel between the transflective display panel and the backlight module. In addition, according to an embodiment of the present invention, the light-adjusting panel may further include a second color filter layer, so as to enhance the saturation of the display device. In addition, according to an embodiment of the present invention, owing to the design of the first polarizer, the second polarizer, and the third polarizer, the transmittance of the display device may be enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a cross-sectional view of a display device according to a first embodiment of the present invention.

FIG. 2 schematically illustrates a structural exploded view of the display device according to the first embodiment of the present invention.

FIG. 3 schematically illustrates a cross-sectional view of a display device according to a second embodiment of the present invention.

FIG. 4 schematically illustrates a structural exploded view of the display device according to the second embodiment of the present invention.

FIG. 5 schematically illustrates a cross-sectional view of a display device according to a third embodiment of the present invention.

FIG. 6 schematically illustrates a structural exploded view of the display device according to the third embodiment of the present invention.

FIG. 7 schematically illustrates a cross-sectional view of a display device according to a fourth embodiment of the present invention.

FIG. 8 schematically illustrates a structural exploded view of the display device according to the fourth embodiment of the present invention.

FIG. 9 schematically illustrates a cross-sectional view of a portion of a display device according to a fifth embodiment of the present invention.

FIG. 10 schematically illustrates a cross-sectional view of a portion of a display device according to a sixth embodiment of the present invention.

FIG. 11 schematically illustrates a structural exploded view of the display device according to the sixth embodiment of the present invention.

FIG. 12 schematically illustrates a cross-sectional view of a portion of a display device according to a seventh embodiment of the present invention.

FIG. 13 schematically illustrates a cross-sectional view of a portion of a display device according to an eighth embodiment of the present invention.

FIG. 14 schematically illustrates a cross-sectional view of a portion of a display device according to a ninth embodiment of the present invention.

### DETAILED DESCRIPTION

To provide a better understanding of the present invention to those skilled in this field, preferred embodiments will be detailed as follows. The preferred embodiments of the present invention are illustrated in the accompanying drawings to elaborate on the contents and effects to be achieved. It should be noted that the drawings are simplified schematics, and therefore show only the components and combinations associated with the present invention, in order to provide a clearer description of the basic architecture or method of implementation. The components would be complex in reality. In addition, for ease of explanation, the components shown in the drawings may not represent their actual number, shape, and dimensions; details can be adjusted according to design requirements.

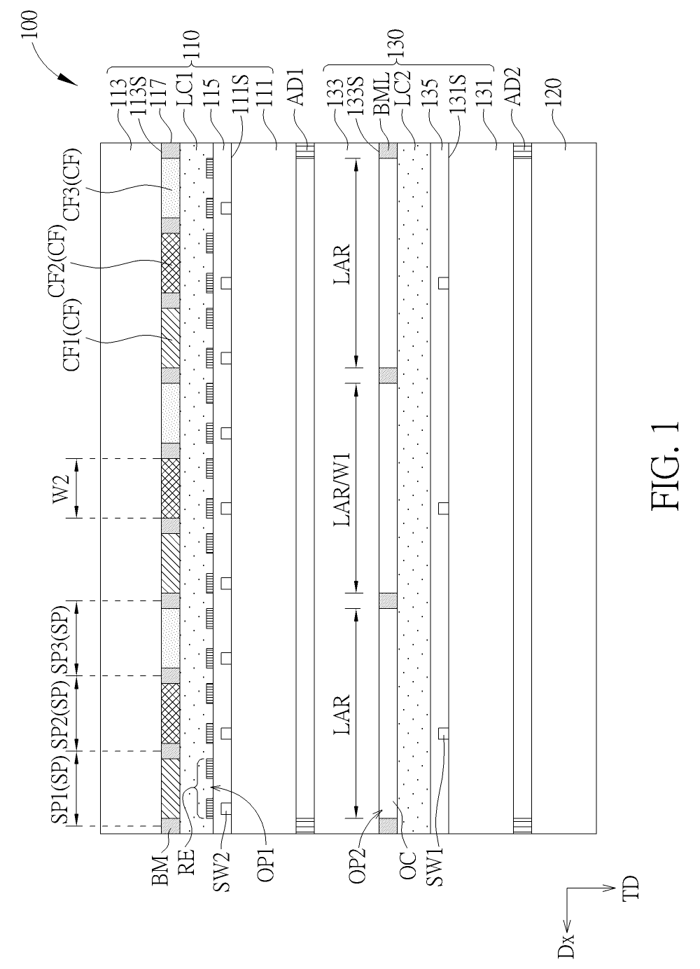

Refer to FIG. 1. FIG. 1 schematically illustrates a cross-sectional view of a display device according to a first embodiment of the present invention. The first embodiment of the present invention provides a display device 100 including a transflective display panel 110, a backlight module 120, and a light-adjusting panel 130, wherein the backlight module 120 is disposed on a side of the transflective display panel 110, and the light-adjusting panel 130 is disposed between the transflective display panel 110 and the backlight module 120. The transflective display panel 110 has a plurality of sub-pixels SP, and the transflective display panel 110 includes a first substrate 111, a first circuit layer 115, a plurality of reflective electrodes RE, a first color filter layer 117, a first liquid crystal layer LC1, and a second substrate 113 sequentially disposed from bottom to top. In addition, the second substrate 113 is disposed opposite to the first substrate 111, the first circuit layer 115 is disposed on a surface 111S of the first substrate 111, the reflective electrodes RE are disposed on the first circuit layer 115, the first color filter layer 117 includes a plurality of color filters CF and is disposed on a surface 113S of the second substrate 113, and the first liquid crystal layer LC1 is disposed between the color filters CF and the reflective electrodes RE. Each of the reflective electrodes RE includes an opening OP1, and each of the color filters CF corresponds to one of the reflective electrodes RE and is disposed in one of the sub-pixels SP. In other words, each of the reflective electrodes RE corresponds to one sub-pixel SP. The light-adjusting panel 130 includes a third substrate 131, a second circuit layer 135, a second liquid crystal layer LC2, and a fourth substrate 133 sequentially disposed from bottom to top. In addition, the fourth substrate 133 is disposed opposite to the third substrate 131, the second circuit layer 135 is disposed on a surface 131S of the third substrate 131, and the second liquid crystal layer LC2 is disposed between the second circuit layer 135 and the fourth substrate 133.

As shown in FIG. 1, the light-adjusting panel 130 has a plurality of light-adjusting regions LAR, and the second circuit layer 135 of the light-adjusting panel 130 may selectively include a plurality of switching elements SW1 respectively correspond to one of the light-adjusting regions LAR to control an on-off state of the corresponding light-adjusting region LAR. That is, one light-adjusting region LAR may include one switching element SW1. Specifically, the second circuit layer 135 of the light-adjusting panel 130 may further include a plurality of data lines (not shown in the figure), a plurality of scan lines (not shown in the figure), and a plurality of transparent electrodes (not shown in the figure) electrically connected to the corresponding switching elements SW1. Through the scan line, the on-off state of the corresponding switching element SW1 may be controlled, such that the on-off state of the light-adjusting region LAR may be controlled through the corresponding transparent electrode, and a gray level value is provided through the data line to the light-adjusting region LAR. For example, when the switching element SW1 is in the on state, the corresponding light-adjusting region LAR may be in the transparent state; and when the switching element SW1 is in the off state, the corresponding light-adjusting region LAR may be in the non-transparent state, or it may be designed the other way around. Furthermore, the light-adjusting regions LAR of the light-adjusting panel 130 may alternatively be designed to have different degrees of transmittance according to the signals provided by the corresponding data lines. In addition, as shown in FIG. 1, the light-adjusting panel 130 may further include a black matrix layer BML and an overcoating layer OC, wherein the black matrix layer BML is disposed on a surface 133S of the fourth substrate 133. The black matrix layer BML has a plurality of openings OP2 respectively corresponding to one of the light-adjusting regions LAR, and the overcoating layer OC is disposed in the openings OP2 of the black matrix layer BML. It is noteworthy that as shown in FIG. 1, a width W1 of the light-adjusting region LAR in a direction Dx is greater than a width W2 of one color filter CF in the direction Dx. In other words, the size of any one of the light-adjusting regions LAR is greater than the size of any one of the color filters CF, which means the size of each of the light-adjusting regions LAR is greater than the size of any one of the sub-pixels SP. For example, the width W1 may be approximately three times the width W2 or approximately greater than three times the width W2, but not limited thereto.

Furthermore, in the embodiment shown in FIG. 1, the first circuit layer 135 of the transflective display panel 110 includes a plurality of switching elements SW2, a plurality of data lines (not shown in the figure), a plurality of scan lines (not shown in the figure), and a plurality of pixel electrodes (not shown in the figure) electrically connected to the corresponding switching elements SW2 respectively, and each of the pixel electrodes may be electrically connected to one of the reflective electrodes RE. The scan lines may control the on-off states of the corresponding switching elements SW2, such that the on-off states of the sub-pixels SP may be controlled through the corresponding pixel electrodes, and the data lines may provide gray level values to the corresponding sub-pixels SP. In addition, the color filters CF of the first color filter layer 117 may include a plurality of first color filters CF1, a plurality of second color filters CF2, and a plurality of third color filters CF3. The first color filters CF1, the second color filters CF2, and the third color filters CF3 may respectively be color filters with different colors, and for example, respectively be red color filters, green color filters, and blue color filters, but not limited thereto. In this embodiment, the sub-pixels SP corresponding to the first color filters CF1 are first sub-pixels SP1, the sub-pixels SP corresponding to the second color filters CF2 are a second sub-pixel SP2, and the sub-pixels SP corresponding to the third color filters CF3 are third sub-pixel SP3, and for example, the first sub-pixels SP1, the second sub-pixels SP2, and the third sub-pixels SP3 are respectively red sub-pixels, green sub-pixels, and blue sub-pixels, but not limited thereto. Moreover, the first color filter layer 117 may further include a black matrix BM disposed between any two adjacent color filters CF to reduce the cross-talk problem of light with different colors between the sub-pixels SP. The ambient light reflected by the reflective electrodes RE and/or light produced by the backlight module 120 after passing through the openings OP1 of the reflective electrodes RE may enable the display device 100 to display colorful image after passing through the color filters CF of different colors in the first color filter layer 117.

The backlight module 120 is disposed on a side of the transflective display panel 110 opposite to the light-adjusting panel 130, light produced by the backlight module 120 may be emitted from its upper surface, and after the light passing through the light-adjusting panel 130, the transflective display panel 110 is provided with a light source. The backlight module 120 of this embodiment may be turned on or off according to the display mode. For example, as the display device 100 is operated in the transmissive mode, the backlight module 120 may be turned on to provide a backlight source, and the produced light may pass through the openings OP1 of the reflective electrodes RE such that the sub-pixels SP can display an image; as the display device 100 is operated in the reflective mode, the backlight module 120 may be turned off and not provide a backlight source, and in the meantime, the ambient light reflected by the reflective electrodes RE may be taken as the light source of the sub-pixels SP to enable the transflective display panel 110 to display an image; as the display device 100 is operated in the transflective mode, the backlight module 120 may be turned on for producing light, after passing through the light-adjusting regions LAR of the light-adjusting panel 130 and the openings OP1 of the reflective electrodes RE, the produced light may serve as a part of light source of the sub-pixels SP, and in the meantime, the ambient light reflected by the reflective electrodes RE may be taken as another part of light source of the sub-pixels SP, such that the sub-pixels SP can display an image. The present invention is not limited to the aforementioned contents.

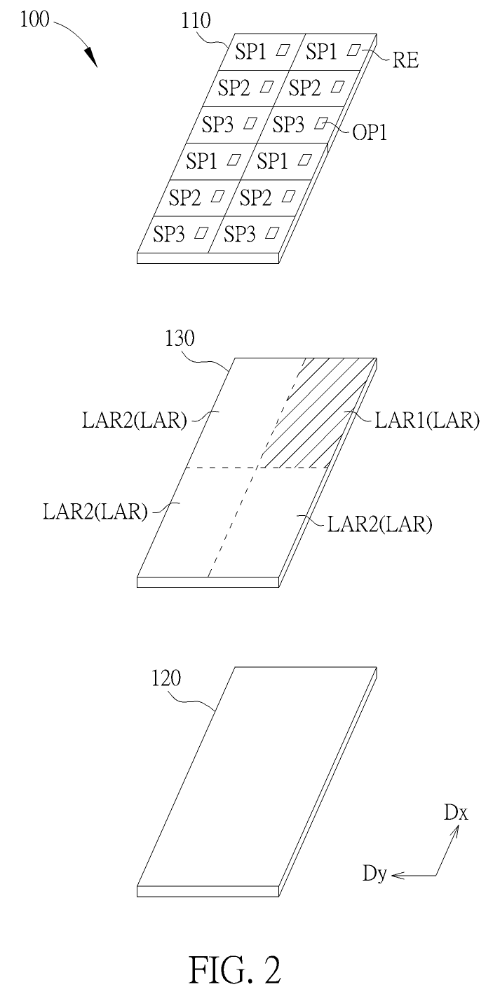

Refer to FIG. 2, and also refer to FIG. 1. FIG. 2 schematically illustrates a structural exploded view of the display device according to the first embodiment of the present invention. It is noted that in order to simplify the illustrations and to clearly describe the features of the present invention, FIG. 2 only illustrates the backlight module 120, configurations of the sub-pixels SP of the transflective display panel 110 and the corresponding reflective electrodes RE, and the areas of the light-adjusting regions LAR of the light-adjusting panel 130 while neglecting other components of the light-adjusting panel 130 and the transflective display panel 110 (e.g., neglecting the first substrate 111, the third substrate 131, the switching elements SW1, and the switching elements SW2). According to the present invention, the light-adjusting panel 130 may individually control the on-off state of each of the light-adjusting regions LAR, such that a brightness difference between different light-adjusting regions LAR may be increased, and therefore a brightness difference between the sub-pixels SP corresponding to the different light-adjusting regions LAR may be increased, which enhances the contrast ratio of the display device 100. Specifically, a plurality of sub-pixels SP may correspond to one light-adjusting region LAR. For example, three sub-pixels, which are the first sub-pixel SP1, the second sub-pixel SP2, and the third sub-pixel SP3, with different colors may correspond to one light-adjusting region LAR, but not limited thereto. The quantity of the sub-pixels SP corresponding to one light-adjusting region LAR may vary depending on designs in practice. According to the degree of transparency of the light-adjusting region LAR, the backlight brightness obtained by the corresponding sub-pixels SP may be determined. Taking the disclosure shown in FIG. 2 as an example, a light-adjusting region LAR1 (marked with slashed lines in FIG. 2) is in the non-transparent or low transparent state, and a light-adjusting region LAR2 (marked blankly in FIG. 2) adjacent to the light-adjusting region LAR1 in the direction Dy or the direction Dx is in the transparent state. Since the brightness difference between the light-adjusting region LAR1 and the light-adjusting region LAR2 is greater, the brightness difference between the sub-pixels SP corresponding to the light-adjusting region LAR1 and the sub-pixels SP corresponding to the light-adjusting region LAR2 may be greater, such that the contrast ratio of the display device 100 may be enhanced. In this embodiment, the direction Dy may be perpendicular to the direction Dx.

Refer to FIG. 1. As shown in FIG. 1, in this embodiment, the quantity of the switching elements SW2 of the first circuit layer 115 of the transflective display panel 110 is greater than the quantity of the switching elements SW1 of the second circuit layer 135 of the light-adjusting panel 130. In other words, the quantity of the sub-pixels SP is greater than the quantity of the light-adjusting regions LAR of the display device 100, and that is, one light-adjusting region LAR may correspond to multiple sub-pixels SP. In the embodiment shown in FIG. 1, one light-adjusting region LAR may correspond to three sub-pixels SP, but not limited thereto. In an embodiment, one light-adjusting region LAR may correspond to 300 sub-pixels SP, but not limited thereto. In another embodiment, the transflective display panel 110 may have a resolution of 1920×1080, which means it has 5760×3240 sub-pixels SP, while the light-adjusting panel 130 may have 480×360 light-adjusting regions LAR, but not limited thereto. In still another embodiment, the transflective display panel 110 may have a resolution of 1920×1080, which means it has 5760×3240 sub-pixels SP, while the light-adjusting panel 130 may have 384 light-adjusting regions LAR, but not limited thereto.

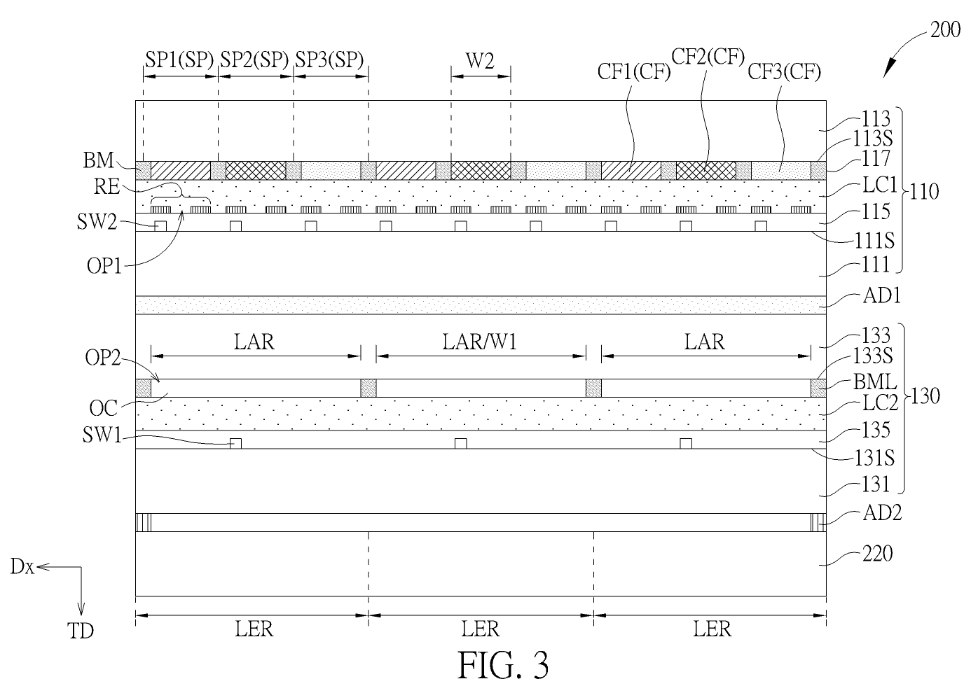

In addition, as shown in FIG. 1, the transflective display panel 110, the light-adjusting panel 130, and the backlight module 120 may be individually fabricated. Then, the transflective display panel 110 may be fixed onto the top side of the light-adjusting panel 130 through a first adhesive layer AD1, and the backlight module 120 may be fixed onto the bottom side of the light-adjusting panel 130 through a second adhesive layer AD2, such that the display device 100 is formed. In the embodiment shown in FIG. 1, the first adhesive layer AD1 and the second adhesive layer AD2 may include a frame adhesive, such as a double-sided tape, but not limited thereto. In some embodiments, the first adhesive layer AD1 may alternatively include an optically clear adhesive as shown in FIG. 3, which is blanket-coated on the entire surface between the transflective display panel 110 and the light-adjusting panel 130, but not limited thereto.

The first substrate 111, the second substrate 113, the third substrate 131, and the fourth substrate 133 may individually include a rigid substrate or a flexible substrate. The rigid substrate, for example, includes glass, ceramic, quartz, or sapphire, and the flexible substrate, for example, includes polyimide (PI), polycarbonate (PC), polycarbonate (PC), polyethylene terephthalate (PET), or poly(methyl methacrylate) (PMMA), but not limited thereto. In this embodiment, the material of the overcoating layer OC may include colorless material(s), but not limited thereto. The reflective electrodes RE may include metal(s) with high reflectivity, such as silver, aluminum, alloy of the aforementioned metals, or other suitable materials, but not limited thereto. The switching elements SW1 and the switching elements SW2 may include thin film transistors, but not limited thereto. In this embodiment, the first liquid crystal layer LC1 may include the same liquid crystal material as the second liquid crystal layer LC2, but not limited thereto. In some embodiments, the first liquid crystal layer LC1 and the second liquid crystal layer LC2 may include different liquid crystal materials. The backlight module 120 may, for example, include a direct-lit type backlight source, an edge-lit type backlight source, or other suitable backlight source.

The display device of the present invention is not limited to the aforementioned embodiment. The following description continues to detail other embodiments. To simplify the description and emphasize the difference between embodiments, identical components in each of the following embodiments are marked with identical symbols, and the identical features will not be redundantly described. In addition, all of the following embodiments may achieve the effect described in the first embodiment.

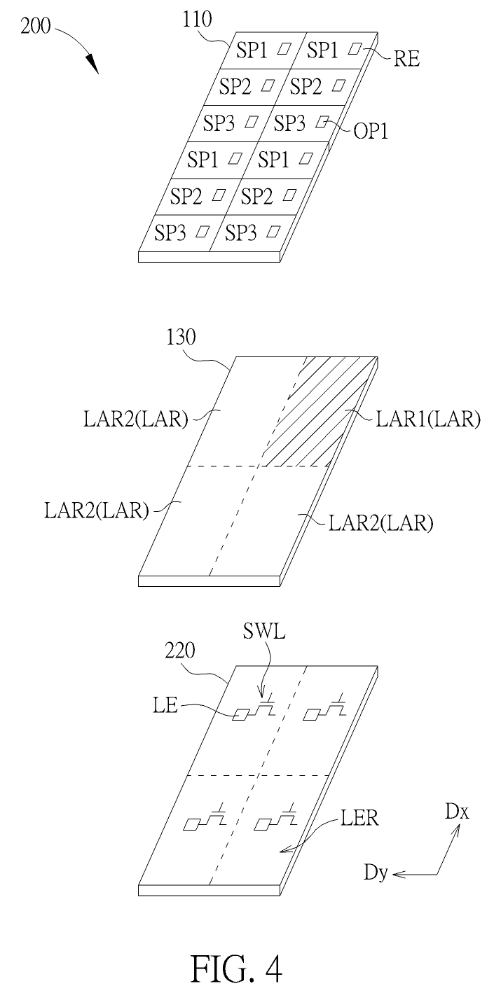

Refer to FIG. 3 and FIG. 4. FIG. 3 schematically illustrates a cross-sectional view of a display device according to a second embodiment of the present invention, and FIG. 4 schematically illustrates a structural exploded view of the display device according to the second embodiment of the present invention. As shown in FIG. 4, a difference between a display device 200 provided by this embodiment and the display device 100 shown in FIG. 1 is that the backlight module 220 is a backlight module capable of local dimming. The backlight module 220 may include a plurality of light emitting elements LE and a plurality of backlight switching elements SWL, and the light emitting elements LE are respectively electrically connected to one corresponding backlight switching element SWL. In addition, as shown in FIG. 4, each of the light emitting elements LE may correspond to one light emitting region LER, and the backlight switching element SWL may control the on-off state of the light emitting element LE. In other words, each of the light switching elements SWL may independently control the on-off state of the corresponding light emitting region LER. The light emitting elements LE may include organic light emitting diodes (OLEDs), mini LEDs, and/or micro LEDs, but not limited thereto.

As shown in FIG. 3 and FIG. 4, in this embodiment, one light emitting region LER may correspond to one light-adjusting region LAR, which means that the quantity of the light emitting regions LER may be identical to the quantity of the light-adjusting regions LAR, and that is, the quantity of the switching elements SW1 of the second circuit layer 135 may be equal to the quantity of the backlight switching elements SWL, but not limited thereto. In some embodiments, one light emitting region LER may correspond to multiple light-adjusting regions LAR, which means that the quantity of the light emitting regions LER may be less than the quantity of the light-adjusting regions LAR, and that is, the quantity of the switching elements SW1 of the second circuit layer 135 may be greater than the quantity of the backlight switching elements SWL, but not limited thereto. In this embodiment, by controlling the on-off state of each of the light emitting regions LER and by controlling the on-off state or the degree of transparency of each of the light-adjusting regions LAR, the brightness difference of light passing through the individual light-adjusting region LAR may be increased, such that the brightness difference between the corresponding sub-pixels SP may be increased, which enhances the contrast ratio of the display device 200.

Furthermore, as shown in FIG. 3, another difference between this embodiment and the display device 100 shown in FIG. 1 is that the first adhesive layer AD1 of the display device 200 may include an optically clear adhesive, which is blanket-coated on the entire surface between the transflective display panel 110 and the light-adjusting panel 130, but not limited thereto. For example, in a modified embodiment, the first adhesive layer AD1 of the display device 200 may alternatively include the frame adhesive. Other parts of the display device 200 of this embodiment may be referred to the aforementioned first embodiment, and they are not redundantly described herein.

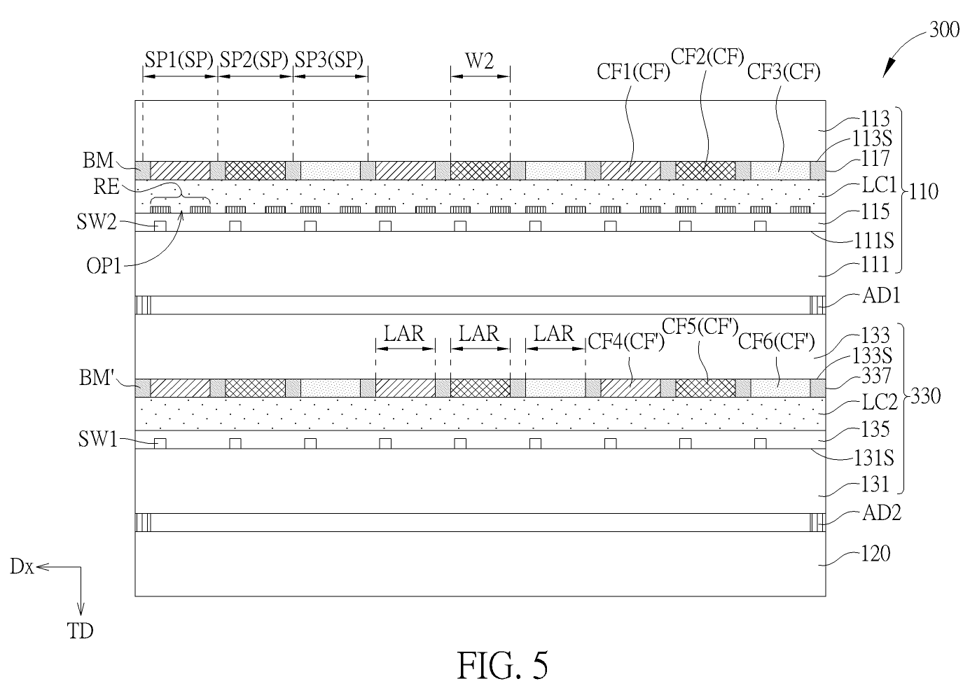

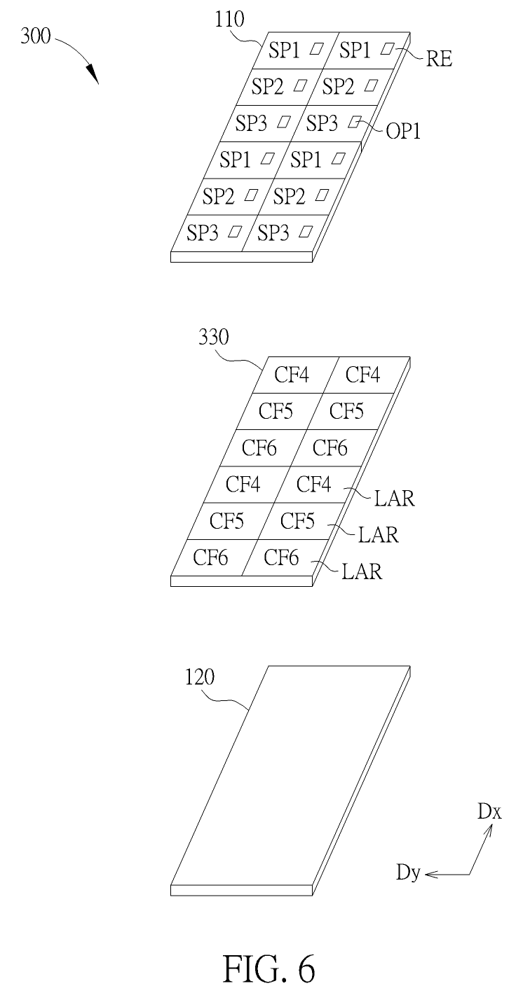

Refer to FIG. 5 and FIG. 6. FIG. 5 schematically illustrates a cross-sectional view of a display device according to a third embodiment of the present invention, and FIG. 6 schematically illustrates a structural exploded view of the display device according to the third embodiment of the present invention. In order to simplify the figure, the light-adjusting panel 330 only illustrates the second color filter layer 337, the transflective display panel 110 only illustrates the configurations of the reflective electrodes RE and the sub-pixels SP, and other elements are omitted in FIG. 6. As shown in FIG. 5 and FIG. 6, a difference between a display device 300 provided by this embodiment and the display device 100 shown in FIG. 1 is that the light-adjusting panel 330 may further include a second color filter layer 337 disposed between the second liquid crystal layer LC2 and the fourth substrate 133. The second color filter layer 337 may include a plurality of color filters CF’. In a top view direction TD of the display device 300, the color filters CF’ of the second color filter layer 337 may respectively correspond to and overlap one of the color filters CF of the first color filter layer 117. Specifically, as shown in FIG. 5, the color filters CF’ may also include a plurality of first color filters CF4, a plurality of second color filters CF5, and a plurality of third color filters CF6, wherein in the top view direction TD, the first color filters CF4 of the second color filter layer 337 may correspondingly overlap the first color filters CF1 of the first color filter layer 117, the second color filters CF5 may correspondingly overlap the second color filter CF2, and the third color filters CF6 may correspondingly overlap the third color filters CF3. The second color filter layer 337 may further include a black matrix BM’ disposed between two adjacent color filters CF’ to reduce the cross-talk problem of light.

Colors of the color filters CF’ of the second color filter layer 337 may respectively be identical to the corresponding first color filters CF1, the corresponding second color filters CF2, or the corresponding third color filters CF3. For example, the first color filters CF4, the second color filters CF5, and the third color filters CF6 may respectively be red color filters, green color filters, and blue color filters, but not limited thereto. In this embodiment, the first color filters CF4, the second color filters CF5, and the third color filters CF6 of the second color filter layer 337 may include the same materials as the first color filters CF1, the second color filters CF2, and the third color filters CF3 of the first color filter layer 117 respectively, but not limited thereto. In some other embodiments, the materials of the first color filters CF4, the second color filters CF5, and the third color filters CF6 of the second color filter layer 337 may not be identical to those of the first color filters CF1, the second color filters CF2, and the third color filters CF3 of the first color filter layer 117.

In this embodiment, by disposing the second color filter layer 337 in the light-adjusting panel 330, light emitted from the backlight source 120 first passes through the color filters CF’ of the second color filter layer 337, then, passes through the openings OP1 of the reflective electrodes RE, and finally, passes through the corresponding color filters CF of the first color filter layer 117, which consequently may enhance the color saturation of the display device 300. In addition, the on-off state or the degree of transparency of each of the light-adjusting regions LAR may also be controlled through the switching elements SW1 of the light-adjusting panel 330, such that the brightness difference between each of the light-adjusting regions LAR may be enhanced. Consequently, the sub-pixels SP corresponding to the light-adjusting regions LAR with different degrees of transparency may have a greater brightness difference, such that the contrast ratio of the display device 300 may be enhanced. Other parts of the display device 300 of this embodiment may be referred to the aforementioned embodiments, and they are not redundantly described herein.

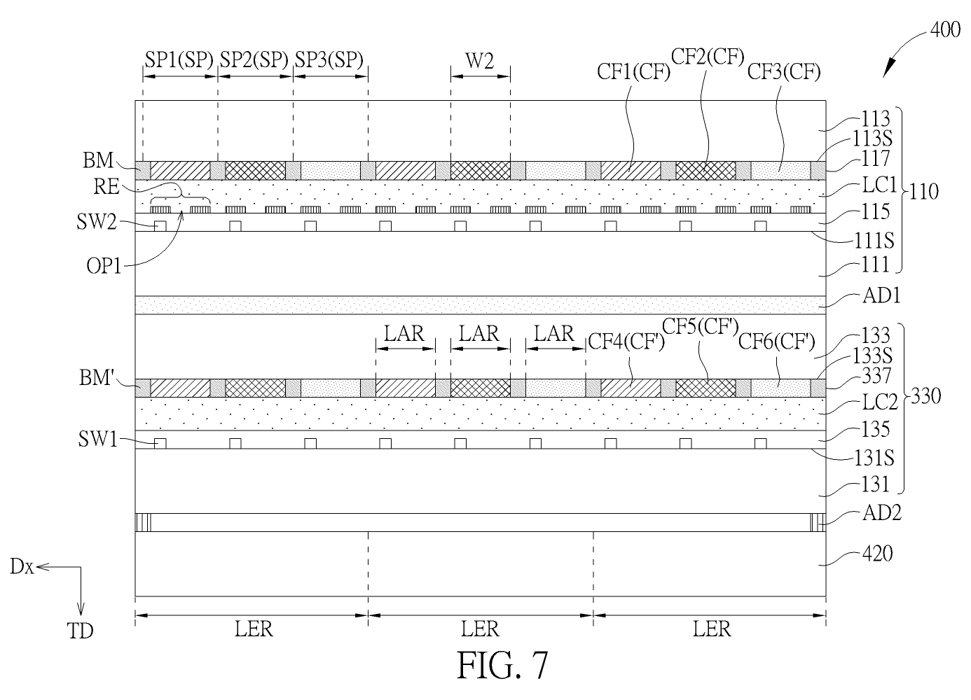

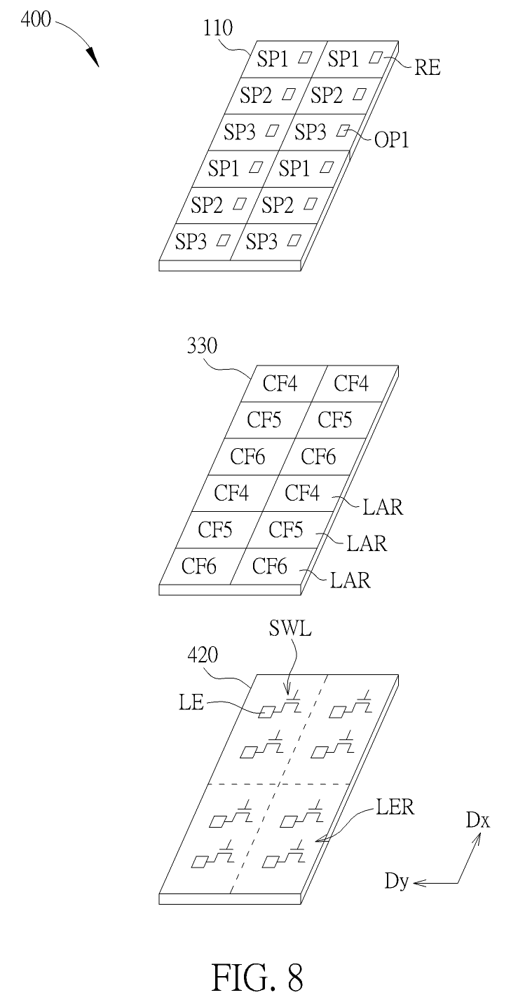

Refer to FIG. 7 and FIG. 8. FIG. 7 schematically illustrates a cross-sectional view of a display device according to a fourth embodiment of the present invention, and FIG. 8 schematically illustrates a structural exploded view of the display device according to the fourth embodiment of the present invention. As shown in FIG. 8, a difference between a display device 400 provided by this embodiment and the display device 300 shown in FIG. 5 is that the backlight module 420 may include a plurality of light emitting elements LE and a plurality of backlight switching elements SWL as mentioned in the embodiment shown in FIG. 4, and the light emitting elements LE are respectively electrically connected to one of the backlight switching elements SWL. As shown in FIG. 8, one light emitting region LER may include a plurality of light emitting elements LE, and each of the backlight switching elements SWL may control the on-off state of the corresponding light emitting element LE, such that the on-off state of each light emitting region LER may be controlled individually. In a modified embodiment, the plurality of light emitting units LE of one light emitting region LER may be electrically connected to one backlight switching element SWL, and that is, one backlight switching element SWL may control the on-off states of all light emitting elements LE in a single light emitting region LER, but not limited thereto. As shown in FIG. 7, in this embodiment, one light emitting region LER may correspond to three light-adjusting regions LAR, and therefore the quantity of the switching elements SW1 of the second circuit layer 135 may be greater than the quantity of the backlight switching elements SWL, but not limited thereto. In this embodiment, by controlling the on-off states of the light emitting regions LER and by controlling the on-off states or the degrees of transparency of the light-adjusting regions LAR, the brightness difference between different light-adjusting regions LAR may be increased. Consequently, the brightness difference between the sub-pixels SP respectively corresponding to different light-adjusting regions LAR may be increased, such that the contrast ratio of the display device 400 may be enhanced. In addition, by disposing the second color filter layer 337 in the light-adjusting panel 330, light emitted from the backlight module 420 firstly passes through the color filters CF’ of the second color filter layer 337, then, passes through the openings OP1 of the reflective electrodes RE, and finally, passes through the corresponding color filters CF of the first color filter layer 117, which consequently may enhance the color saturation of the display device 400. Other parts of the display device 400 of this embodiment may be referred to the aforementioned first embodiment, and they are not redundantly described herein.

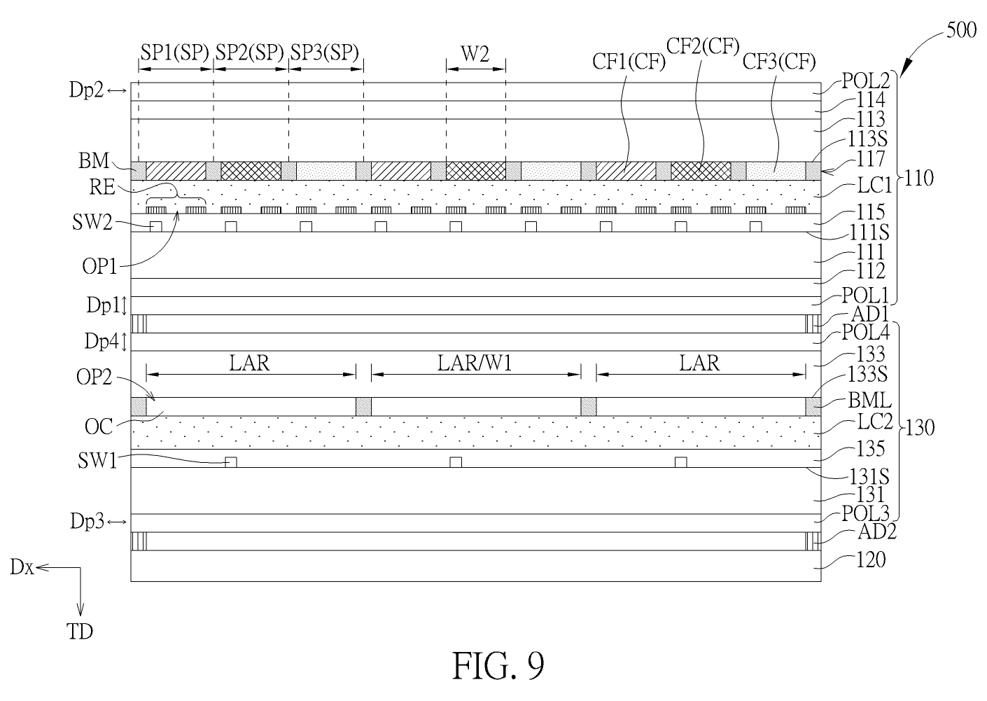

Refer to FIG. 9. FIG. 9 schematically illustrates a cross-sectional view of a portion of a display device according to a fifth embodiment of the present invention. The fifth embodiment of the present invention provides a display device 500 composed of components similar to the display device 100 shown in FIG. 1. The differences between the display device 500 and the display device 100 are described below. As shown in FIG. 9, the transflective display panel 110 of the display device 500 further includes a first polarizer POL1, a first quarter wave plate 112, a second quarter wave plate 114, and a second polarizer POL2. The second polarizer POL2 is disposed opposite to the first polarizer POL1, the first liquid crystal layer LC1 is disposed between the first polarizer POL1 and the second polarizer POL2, the first quarter wave plate 112 is disposed between the first liquid crystal layer LC1 and the first polarizer POL1, the second quarter wave plate 114 is disposed between the first liquid crystal layer LC1 and the second polarizer POL2, the first substrate 111 is disposed between the first quarter wave plate 112 and the first liquid crystal layer LC1, and the second substrate 113 is disposed between the second quarter wave plate 114 and the first liquid crystal layer LC1.

As shown in FIG. 9, the transflective display panel 110 includes the plurality of sub-pixels SP, and each of the sub-pixels SP may include, but not limited to, a portion of the first polarizer POL1, a portion of the first quarter wave plate 112, a portion of the first substrate 111, a portion of the first liquid crystal layer LC1, a portion of the second substrate 113, a portion of the second quarter wave plate 114, a portion of the second polarizer POL2, a portion of the first circuit layer 115, one of the reflective electrodes RE, and one of the color filters CF. As mentioned before, each of the transparent electrodes and the corresponding reflective electrode RE may form a pixel electrode corresponding to one the sub-pixel SP. The voltages applied on the pixel electrodes may control the orientation of the liquid crystal molecules in the first liquid crystal layer LC1 to adjust the polarization direction of light passing through the first liquid crystal layer LC1, and by combining with the polarization characteristics of the first polarizer POL1, the first quarter wave plate 112, the second quarter wave plate 114, and the second polarizer POL2, the gray level values of the corresponding sub-pixel SP may be controlled.

In the embodiment shown in FIG. 9, the first polarizer POL1 has a first transmission axis direction Dp1, the second polarizer POL2 has a second transmission axis direction Dp2, and the second transmission axis direction Dp2 of the second polarizer POL2 is perpendicular to the first transmission axis direction Dp1 of the first polarizer POL1, but not limited thereto. In addition, by combining the first transmission axis direction Dp1 and the second transmission axis direction Dp2 with the structure of the first liquid crystal layer LC1, the transflective display panel 110 may present a bright state or a dark state without applying voltage on the liquid crystal molecules. For example, the alignment direction of the alignment layer adjacent to the first polarizer POL1 of the transflective display panel 110 may be parallel or perpendicular to the first transmission axis direction Dp1 of the first polarizer POL1. The above-mentioned the term “the structure of the liquid crystal layer LC1” may, for example, indicate the alignment directions adjacent to the first polarizer POL1 and the second polarizer POL2 and/or the thickness and material of the first liquid crystal layer LC1. In some embodiments, the second transmission axis direction Dp2 of the second polarizer POL2 may be parallel to the first transmission axis direction Dp1 of the first polarizer POL1.

In addition, the light-adjusting panel 130 further comprises a third polarizer POL3 and a fourth polarizer POL4. The second liquid crystal layer LC2 is disposed between the third polarizer POL3 and the fourth polarizer POL4. As shown in FIG. 9, the third substrate 131 is disposed between the second liquid crystal layer LC2 and the third polarizer POL3, the fourth substrate 133 is disposed between the first polarizer POL1 and the second liquid crystal layer LC2, the fourth polarizer POL4 is disposed between the first polarizer POL1 and the second liquid crystal layer LC2, and the fourth polarizer POL4 is disposed opposite to the third polarizer POL3.

As mentioned before, the on-off state of the switching element SW1 may be controlled through the corresponding scan line, and in the meantime, the voltage signal of the transmittance of the corresponding light-adjusting region LAR may be transmitted through the data line, such that the corresponding transparent electrode of the light-adjusting panel 130 may receive the corresponding voltage, which consequently may control the polarization direction of light passing through the second liquid crystal layer LC2. In addition, in combination with the third polarizer POL3 and the fourth polarizer POL4, the transmittance of the light-adjusting region LAR may be controlled. Different transmittances of the light-adjusting region LAR may, for example, correspond to different gray level voltages, and thus to different gray level values of the light-adjusting region LAR.

For example, the third polarizer POL3 has a third transmission axis direction Dp3, the fourth polarizer POL4 has a fourth transmission axis direction Dp4, and the third transmission axis direction Dp3 of the third polarizer POL3 is perpendicular to the fourth transmission axis direction Dp4 of the fourth polarizer POL4, but not limited thereto. By combining the third transmission axis direction Dp3 and the fourth transmission axis direction Dp4 with the structure of the second liquid crystal layer LC2, the light-adjusting region LAR may present low transmittance or high transmittance without applying voltage on the liquid crystal molecules. For example, the alignment direction of the alignment layer adjacent to the third polarizer POL3 of the light-adjusting panel 130 may be parallel or perpendicular to the third transmission axis direction Dp3 of the third polarizer POL3. In some embodiments, the third transmission axis direction Dp3 may be parallel to the fourth transmission axis direction Dp4. In addition, the first transmission axis direction Dp1 of the first polarizer POL1 may be parallel to or approximately parallel to the fourth transmission axis direction Dp4 of the fourth polarizer POL4, but not limited thereto. It is noted that the second transmission axis direction Dp2 and the third transmission axis direction Dp3 shown with the horizontal double-arrowed direction in FIG. 9 may, for example, represent being parallel to the direction Dx, and the first transmission axis direction Dp1 and the fourth transmission axis direction Dp4 shown with the vertical double-arrowed direction may, for example, represent being perpendicular to the direction Dx (i.e., parallel to the direction Dy of FIG. 2), but not limited thereto. Other parts of the display device 500 of this embodiment may be referred to the aforementioned first embodiment, and they are not redundantly described herein.

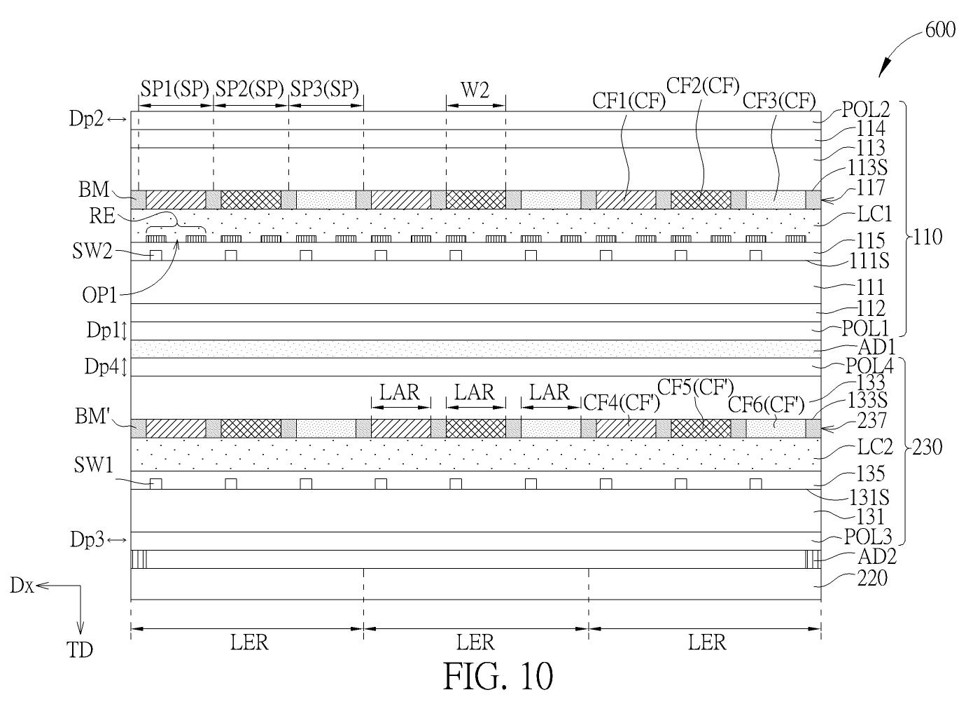

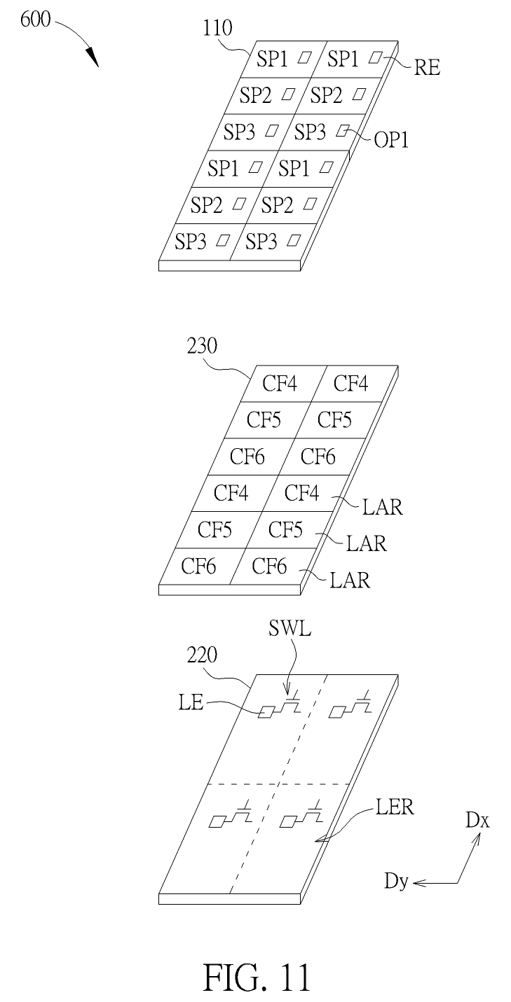

Refer to FIG. 10 and FIG. 11, wherein FIG. 10 schematically illustrates a cross-sectional view of a portion of a display device according to a sixth embodiment of the present invention, and FIG. 11 schematically illustrates a structural exploded view of the display device according to the sixth embodiment of the present invention. In order to simplify the figure, the light-adjusting panel 230 only shows the second color filter layer 237 and the transflective display panel 110 only shows the configurations of the reflective electrodes RE and the sub-pixels SP in FIG. 11, and other elements are omitted in FIG. 11. As shown in FIG. 10, a difference between a display device 600 provided by this embodiment and the display device 500 shown in FIG. 9 is that the light-adjusting panel 230 further includes a second color filter layer 237 disposed between the second liquid layer LC2 and the fourth substrate 133. The second color filter layer 237 may include the color filters CF’ with different colors and the black matrix BM’ disposed between two adjacent color filters CF’. The color filters CF’ may include different colors, and the arrangement and the color correspondence between the color filters CF’ and the color filters CF may be referred to the second color filter layer 337 in FIG. 7, which are not described redundantly herein. Another difference between the display device 600 and the display device 500 is that the backlight module 220 of the display device 600 is a backlight module capable of local dimming, and the structures and functionality thereof can be referred to the embodiment shown in FIG. 4, which are not described redundantly herein. As shown in FIG. 10 and FIG. 11, in this embodiment, one light emitting region LER corresponds to multiple light-adjusting regions LAR. That is, the quantity of the light emitting regions LER is less than the quantity of the light-adjusting regions LAR, which means the quantity of the switching elements SW1 of the second circuit layer 135 is greater than the quantity of the backlight switching elements SWL, but not limited thereto. Furthermore, as shown in FIG. 10, still another difference between this embodiment and the display device 500 shown in FIG. 9 is that the first adhesive layer AD1 of the display device 600 includes optically clear adhesive, which is blanket-coated on the entire surface between the transflective display panel 110 and the light-adjusting panel 230, but not limited thereto. For example, in a modified embodiment, the first adhesive layer AD1 of the display device may alternatively include a frame adhesive.

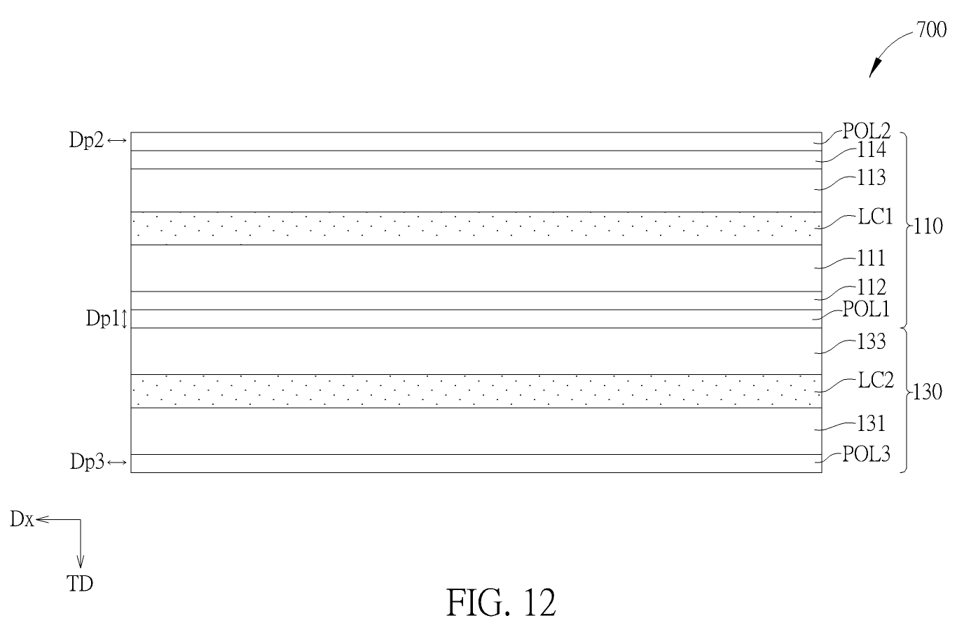

Refer to FIG. 12. FIG. 12 schematically illustrates a cross-sectional view of a portion of a display device according to a seventh embodiment of the present invention. In order to clearly describe the features of the present invention, FIG. 12 only illustrates elements that are able to alter the polarization direction of light (i.e., polarizers, wave plates, and liquid crystal layer) and omits other elements, but the present invention is not limited to the disclosed figure. A difference between a display device 700 of this embodiment and the display device 500 shown in FIG. 9 is that the light-adjusting panel 130 may not include the fourth polarizer POL4 disposed therein. As shown in FIG. 12, since the fourth transmission axis direction Dp4 of the fourth polarizer POL4 is parallel to the first transmission axis direction Dp1 of the first polarizer POL1 as shown in FIG. 9, the polarization direction of light after passing through the fourth polarizer POL4 is identical to the polarization direction of light after passing through the first polarizer POL1, such that the display device 700 of this embodiment may omit the fourth polarizer POL4. In the embodiment of FIG. 12, the third transmission axis direction Dp3 of the third polarizer POL3 is perpendicular to the first transmission axis direction Dp1 of the first polarizer POL1, but not limited thereto. In some other embodiments, to match the structure of the second liquid crystal layer LC2, the third transmission axis direction Dp3 of the third polarizer POL3 may be parallel to the first transmission axis direction Dp1 of the first polarizer POL1. In this embodiment, since the display device 700 may operate normally under the condition of omitting the fourth polarizer POL4 and only including the first polarizer POL1, the second polarizer POL2, and the third polarizer POL3, the transmittance of the display device 700 may be enhanced, and the manufacturing costs and thickness of the display device 700 may be reduced. Other parts of the display device 700 of this embodiment may be referred to the aforementioned fifth embodiment, and they are not redundantly described herein.

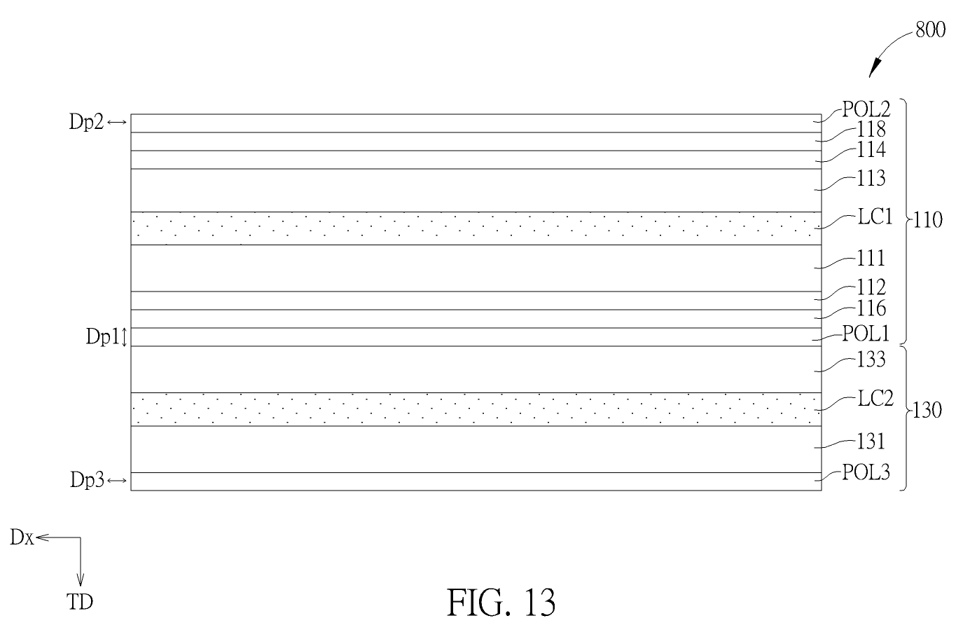

Refer to FIG. 13. FIG. 13 schematically illustrates a cross-sectional view of a portion of a display device according to an eighth embodiment of the present invention. A difference between a display device 800 of this embodiment and the display device 700 of FIG. 12 is that the transflective display panel 110 further includes a first half wave plate 116 disposed between the first quarter wave plate 112 and the first polarizer POL1, and a second half wave plate 118 disposed between the second quarter wave plate 114 and the second polarizer POL2. In some embodiments, the transflective display panel 110 may alternatively and selectively not include the first half wave plate 116 and/or the second half wave plate 118. The first half wave plate 116 and the second half wave plate 118 may adjust and/or compensate the phase of light of different colors, such that the image quality of the display device 800 may be enhanced. Other parts of the display device 800 of this embodiment may be referred to the aforementioned fifth embodiment, and they are not redundantly described herein. In some embodiments, the structure of the display device 800 including the first half wave plate 116 and/or the second half wave plate 118 can also be applied to the display device 500 of FIG. 9.

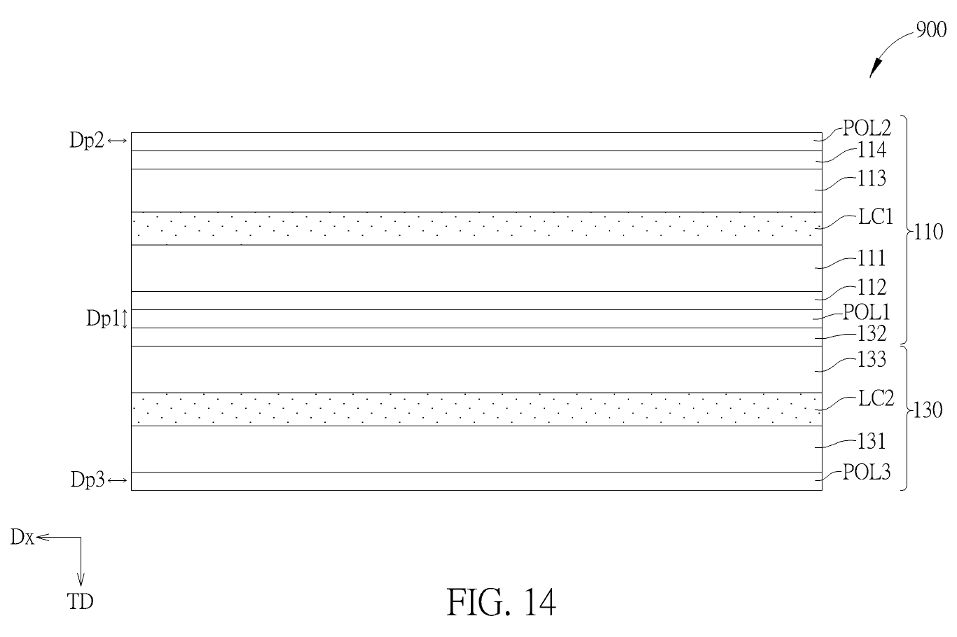

Refer to FIG. 14. FIG. 14 schematically illustrates a cross-sectional view of a portion of a display device according to a ninth embodiment of the present invention. A difference between a display device 900 of this embodiment and the display device 700 of FIG. 12 is that the light-adjusting panel 130 further includes a half wave plate 132 disposed between the second liquid crystal layer LC2 and the first polarizer POL1. In the embodiment of FIG. 14, light emitted from the backlight module 120 becomes a linear polarized light after passing through the third polarizer POL3, the linear polarized light then experiences an effect of phase retardation after passing the second liquid crystal layer LC2, and finally, the light passes through the half wave plate 132 with a half wavelength of phase retardation, such that majority of the light may pass through the first polarizer POL1, and therefore the transmittance of the display device 900 is enhanced. In other words, the half wave plate 132 has a fast axis direction Df (or may be referred to as the extraordinary axis direction), an included angle θ1 between the fast axis direction Df of the half wave plate 132 and the first transmission axis direction Dp1 of the first polarizer POL1 is greater than 0 degrees and less than or equal to 45 degrees. Other parts of the display device 900 of this embodiment may be referred to the aforementioned fifth embodiment, and they are not redundantly described herein. In some embodiments, the structure of the light-adjusting panel 130 further including the half wave plate 132 can also be applied to the display device 500 of FIG. 9 or the display device 800 of FIG. 13.

In summary, in the display device of the present invention, by disposing the light-adjusting panel between the transflective display panel and the backlight module and by controlling the on-off state or the degree of transparency of the light-adjusting regions, the brightness difference between each of the light-adjusting regions may be increased, such that the brightness difference between the sub-pixels respectively correspond to the different light-adjusting regions may be increased, which enhances the contrast ratio of the display device. In addition, according to an embodiment of the present invention, the backlight module may be the local dimming backlight module including the plurality of light emitting regions, and each of the light emitting regions includes one or multiple light emitting elements and at least one backlight switching element. Each of the backlight switching elements may control the on-off state of the corresponding light emitting region, such that the brightness difference between each of the light emitting regions may be increased, which further enhances the contrast ratio of the display device. It can be known from the above-mentioned contents, in the display device of the present invention, the quantity of the light-adjusting regions of the light-adjusting panel may be less than or equal to the quantity of the sub-pixels of the transflective display panel, and the quantity of the light emitting regions of the local dimming backlight module may be less than or equal to the quantity of the light-adjusting regions, provided that the quantity of at least one of the sub-pixels, the light-adjusting regions, and the light emitting regions differs from the quantities of the other two. Through the aforementioned designs, the contrast ratio of the image may be increased. Furthermore, according to the present invention, the light-adjusting panel may further include the second color filter layer. Light emitted from the backlight module firstly passes through the color filters of the second color filter layer, and then, passes through the color filters of the first color filter layer, which consequently may enhance the saturation of the display device. In addition, according to an embodiment of the present invention, the display device may operate normally under the condition of only including the first polarizer, the second polarizer, and the third polarizer, thus the transmittance of the display device may be enhanced, and the manufacturing costs and thickness of the display device may be reduced. Moreover, according to an embodiment of the present invention, by disposing the half wave plate in the light-adjusting panel, the transmittance of the display device may be enhanced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device, comprising: a transflective display panel having a plurality of sub-pixels, wherein the transflective display panel comprises: a first substrate;a second substrate disposed opposite to the first substrate; a first circuit layer disposed on a surface of the first substrate; a plurality of reflective electrodes disposed on the first circuit layer, wherein each of the plurality of reflective electrodes comprises an opening; a first color filter layer comprising a plurality of color filters and disposed on a surface of the second substrate, wherein each of the plurality of color filters corresponds to one of the plurality of reflective electrodes and is disposed in one of the plurality of sub-pixels; and a first liquid crystal layer disposed between the plurality of color filters and the plurality of reflective electrodes;a backlight module disposed on a side of the transflective display panel; and a light-adjusting panel disposed between the transflective display panel and the backlight module, wherein the light-adjusting panel comprises: a third substrate; a fourth substrate disposed opposite to the third substrate; a second circuit layer disposed on a surface of the third substrate; and a second liquid crystal layer disposed between the second circuit layer and the fourth substrate.

2. The display device according to claim 1, wherein the light-adjusting panel has a plurality of light-adjusting regions, and the second circuit layer comprises a plurality of switching elements respectively corresponding to one of the plurality of light-adjusting regions to control an on-off state of the corresponding one of the plurality of light-adjusting regions.

3. The display device according to claim 2, wherein the light-adjusting panel further comprises: a black matrix layer disposed on a surface of the fourth substrate, wherein the black matrix layer has a plurality of openings respectively corresponding to one of the plurality of light-adjusting regions; and an overcoating layer disposed in the plurality of openings of the black matrix layer; wherein a size of any one of the plurality of light-adjusting regions is greater than a size of any one of the plurality of color filters.

4. The display device according to claim 2, wherein the first circuit layer comprises a plurality of switching elements, and a quantity of the plurality of switching elements of the first circuit layer is greater than a quantity of the plurality of switching elements of the second circuit layer.

5. The display device according to claim 1, wherein the light-adjusting panel further comprises a second color filter layer disposed between the second liquid crystal layer and the fourth substrate.

6. The display device according to claim 5, wherein the second color filter layer comprises a plurality of color filters, and in a top view direction of the display device, the plurality of color filters of the second color filter layer respectively correspond to and overlap with one of the plurality of color filters of the first color filter layer.

7. The display device according to claim 6, wherein the plurality of color filters of the first color filter layer comprises a plurality of first color filters, a plurality of second color filters, and a plurality of third color filters, and colors of the plurality of color filters of the second color filter layer are respectively identical to the corresponding one of the plurality of first color filters, the plurality of second color filters, and the plurality of third color filters.

8. The display device according to claim 1, wherein the backlight module comprises a plurality of light emitting elements and a plurality of backlight switching elements, and the plurality of light emitting elements respectively are electrically connected to one of the plurality of backlight switching elements.

9. The display device according to claim 8, wherein the second circuit layer comprises a plurality of switching elements, and a quantity of the plurality of switching elements is greater than or equal to a quantity of the plurality of backlight switching elements.

10. The display device according to claim 1, further comprising: a first adhesive layer disposed between the transflective display panel and the light-adjusting panel; and a second adhesive layer disposed between the light-adjusting panel and the backlight module.

11. A display device, comprising: a transflective display panel, comprising: a first polarizer; a second polarizer disposed opposite to the first polarizer; a first liquid crystal layer disposed between the first polarizer and the second polarizer; a first quarter wave plate disposed between the first liquid crystal layer and the first polarizer; a second quarter wave plate disposed between the first liquid crystal layer and the second polarizer; a first substrate disposed between the first quarter wave plate and the first liquid crystal layer; and a second substrate disposed between the second quarter wave plate and the first liquid crystal layer; a backlight module disposed on a side of the transflective display panel; and a light-adjusting panel disposed between the transflective display panel and the backlight module, the light-adjusting panel comprising: a third polarizer; a second liquid crystal layer disposed between the third polarizer and the first polarizer; a third substrate disposed between the second liquid crystal layer and the third polarizer; and a fourth substrate disposed between the first polarizer and the second liquid crystal layer.

12. The display device according to claim 11, wherein the first polarizer has a first transmission axis direction, the second polarizer has a second transmission axis direction, and the second transmission axis direction of the second polarizer is parallel or perpendicular to the first transmission axis direction of the first polarizer.

13. The display device according to claim 11, wherein the first polarizer has a first transmission axis direction, the third polarizer has a third transmission axis direction, and the third transmission axis direction of the third polarizer is parallel or perpendicular to the first transmission axis direction of the first polarizer.

14. The display device according to claim 11, wherein the light-adjusting panel further comprises a half wave plate disposed between the second liquid crystal layer and the first polarizer.

15. The display device according to claim 14, wherein the half wave plate has a fast axis direction, the first polarizer has a first transmission axis direction, an included angle is between the fast axis direction of the half wave plate and the first transmission axis direction of the first polarizer, and the included angle is greater than 0 degrees and less than or equal to 45 degrees.

16. The display device according to claim 11, wherein the transflective display panel further comprises a first half wave plate disposed between the first quarter wave plate and the first polarizer.

17. The display device according to claim 11, wherein the transflective display panel further comprises a second half wave plate disposed between the second quarter wave plate and the second polarizer.

18. The display device according to claim 11, wherein the transflective display panel further comprises: a plurality of reflective electrodes disposed between first substrate and the first liquid crystal layer, wherein each of the plurality of reflective electrodes comprises an opening; and a first color filter layer comprising a plurality of color filters and disposed between the second substrate and the first liquid crystal layer, wherein each of the plurality of color filters corresponds to one of the plurality of reflective electrodes.

19. The display device according to claim 11, wherein the light-adjusting panel has a plurality of light-adjusting regions, and the light-adjusting panel comprises a plurality of switching elements respectively corresponding to one of the plurality of light-adjusting regions to control an on-off state of the corresponding one of the plurality of light-adjusting regions.

20. The display device according to claim 11, wherein the light-adjusting panel further comprises a second color filter layer disposed between the second liquid crystal layer and the fourth substrate.
